(19) United States
(12) Patent Application Publication
(10) Pub. No.: US 2004/0056052 A1
(43) Pub. Date: Mar. 25, 2004

(54) Weighted fluid extraction tube

(76) Inventor: Anthony John Verzino, Catasauqua, PA (US)

Correspondence Address: SIMON, GALASSO & FRANTZ PLC., P.O. Box 26503, Austin, TX, 78755-0503, US

(21) Appl. No.: 10/616,815

(22) Filed: Jul. 10, 2003

Related U.S. Application Data
(60) Provisional application No. 60/396,811, filed on Jul. 18, 2002.

(51) Int. Cl. B67D 5/40

(52) U.S. Cl. 222/464.4; 222/464.3; 222/383.1

(57) ABSTRACT

One embodiment of the disclosures made herein is a fluid dispensing apparatus having a weighted fluid extraction tube. In accordance with such an embodiment, a fluid container includes a neck portion and a closed end generally opposite the neck portion. A body is mounted on the neck portion of the fluid container. A fluid extraction tube is attached at a delivery end thereof to the body. The fluid extraction tube is attached in a manner enabling fluid to be extracted from within the fluid container and dispensed via the body. A weighting element is attached to the fluid extraction tube adjacent to a pick-up end of the fluid extraction tube, thereby providing a weighted fluid extraction tube. The weighting element provides for displacement of the pick-up end of the fluid extraction tube to a gravity-induced position within the fluid container. The weighted fluid extraction tube disclosed herein prevents the pick-up end of the fluid extraction tube from becoming uncovered by fluid when the fluid level within the fluid container drops sufficiently and when the fluid dispensing apparatus is being used in a tilted (e.g., upward or downward) orientation.

### CROSS REFERENCE TO RELATED APPLICATIONS

This application claims priority to co-pending United States Provisional Patent Application having Serial No. 60/396,811 filed Jul. 18, 2002 entitled “Gravit-All Spray Pump System”, having a common applicant herewith.

### FIELD OF THE DISCLOSURE

The disclosures herein relate generally to fluid dispensing apparatuses and more particularly to a fluid extraction tube enabling enhanced fluid extraction.

### BACKGROUND OF THE DISCLOSURE

Various types of fluid dispensing apparatuses rely on a fluid extraction tube for enabling fluid within a fluid container of the fluid dispensing to be extracted. Examples of such types of fluid dispensing apparatuses include manual-pump atomizing fluid dispensers, manual pump non-atomizing fluid dispensers, aerosol spray dispenser, hose-end fluid dispensers and the like. In these types of fluid dispensing apparatuses, the fluid extraction tube is attached to a body of the fluid dispensing apparatus (i.e., a fluid dispensing body). The body is attached to a neck portion of a fluid container of the fluid dispensing apparatus, with the fluid extraction tube extending toward a closed end of the fluid container. Upon a pressure differential being created across the ends (i.e., a fluid delivery end and a fluid pick-up end) of the fluid extraction tube, fluid is communicated through the fluid extraction tube to the body from within the fluid container.

It is typical for these types of fluid dispensing apparatuses to be used in a tilted orientation (e.g., upward or downward). In such a tilted orientation, fluid within the fluid container seeks the lowest point of the fluid container, which is typically at a corner region of the fluid container when the fluid container is in a typical operating orientation. A conventional type of fluid extraction tube (i.e., a conventional fluid extraction tube) is typically made long enough and with a slight arched shape to position a pick-up end of the fluid extraction tube close to a particular corner region of the fluid container. The conventional fluid extraction tube is typically made from a relatively stiff material such that the pick-up end of the fluid extraction tube is biased toward the particular corner region of the fluid container. Thus, even when the fluid level is relatively low and the fluid dispensing apparatuses is being used in a tilted orientation that positions remaining fluid at the particular corner region of the fluid container where the pick-up end of the conventional fluid extraction tube is located, the configuration of the conventional fluid extraction tube (e.g., length, arched shape and/or stiffness) enable fluid to be extracted from the fluid container.

A limitation of conventional fluid extraction tubes is that they have an essentially static position within the fluid container (i.e., the pick-up end of the fluid extraction tube located at the particular corner of the fluid container). This essentially static position results in the pick-up end of the conventional fluid extraction tube becoming uncovered by fluid when the fluid level drops sufficiently and the fluid dispensing apparatuses is being used in a tilted orientation that positions remaining fluid away from the particular corner region of the fluid container where the pick-up end of the conventional fluid extraction tube is located. Under these conditions, the remaining fluid in the fluid container cannot be extracted by the conventional fluid extraction tube without manually changing orientation of the conventional fluid extraction tube and/or changing orientation of the fluid dispensing apparatus. The need to manually change orientation of the conventional fluid extraction tube and/or change orientation of the fluid dispensing apparatus is often undesirable, inefficient and/or impractical.

Therefore, a fluid extraction tube arrangement that overcomes limitations associated with conventional fluid extraction tubes would be useful.

### BRIEF DESCRIPTION OF THE DRAWINGS

FIG. 1 depicts a fluid dispensing apparatus in accordance with an embodiment of the disclosures made herein.

FIG. 2 depicts the embodiment of the weighted fluid extraction tube depicted in FIG. 1, wherein the weighted fluid extraction tube includes a weighting element and a fluid extraction tube extending approximately though a center of mass of the weighting element.

FIG. 3 depicts an embodiment of a weighted fluid extraction tube that includes a bracket attached to a fluid extraction tube and a weight attached to the bracket, wherein the center of mass of the weight is offset from a longitudinal axis of the fluid extraction tube.

FIG. 4 depicts an embodiment of a weighting element that includes a weight portion, a barbed nipple portion integral with the weight portion and a passage extending through the weight portion and the barbed nipple portion, thereby enabling the weighting element to be mounted on the fluid extraction tube by engaging the barbed portion within a pick-up end of the fluid extraction tube.

### DETAILED DESCRIPTION OF THE DRAWINGS

One embodiment of the disclosures made herein is a fluid dispensing apparatus having a weighted fluid extraction tube. In accordance with such an embodiment, a fluid container includes a neck portion and a closed end generally opposite the neck portion. A body is mounted on the neck portion of the fluid container. A fluid extraction tube is attached at a delivery end thereof to the body. The fluid extraction tube is attached in a manner enabling fluid to be extracted from within the fluid container and dispensed via the body. A weighting element is attached to the fluid extraction tube adjacent to a pick-up end of the fluid extraction tube, thereby providing a weighted fluid extraction tube. The weighting element provides for displacement of the pick-up end of the fluid extraction tube to a gravity-induced position within the fluid container. The weighted fluid extraction tube disclosed herein prevents the pick-up end of the fluid extraction tube from becoming uncovered by fluid when the fluid level within the fluid container drops sufficiently and when the fluid dispensing apparatus is being used in a tilted (e.g., upward or downward) orientation.

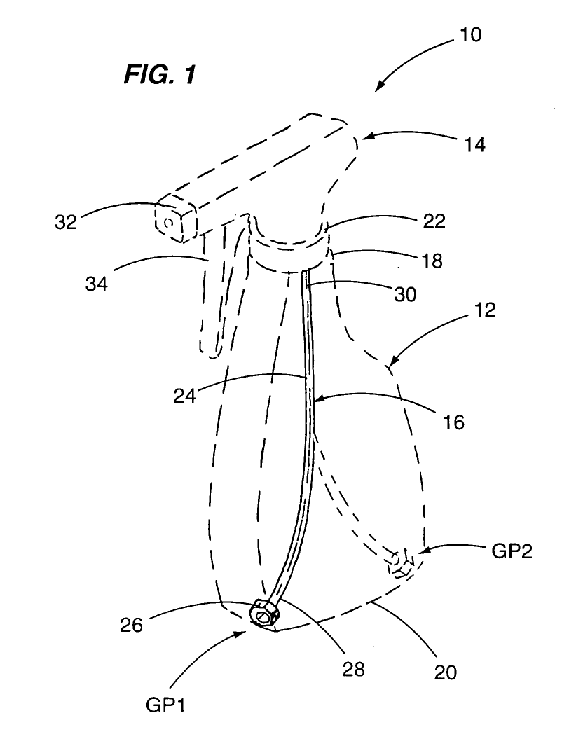

FIG. 1 depicts a fluid dispensing apparatus 10 in accordance with an embodiment of the disclosures made herein. The fluid dispensing apparatus 10 include a fluid container 12, a dispenser head assembly 14 and a weighted fluid extraction tube 16. A fluid extraction assembly comprises the dispenser head assembly 14 and the weighted fluid extraction tube 16.

The fluid container 12 has a neck portion 18 and a closed end 20 generally opposite the neck portion 18. The dispenser head assembly 14 includes a body 22 mounted on the neck portion 18 of the fluid container 12. The weighted fluid extraction tube 16 includes a fluid extraction tube 24 and a weighting element 26 attached to the fluid extraction tube 24 adjacent to a pick-up end 28 of the fluid extraction tube 24. The fluid extraction tube 24 is attached at a delivery end 30 thereof to the body 22 of the dispenser head assembly 14. The fluid extraction tube 24 is attached to the body 22 in a manner enabling fluid to be extracted from within the fluid container 20 and dispensed via the body 22 of the dispenser head assembly 14.

One embodiment of the fluid extraction tube 24 is a flexible tube, such as a tube made of a flexible material or a tube physically configured to enable flexure over its length (e.g., a length of corrugated tube). Preferably, the flexible tube has a degree of flexibility that is dependent upon a particular mass of the weighting element and a maximum specified displacement of the pick-up end of the fluid extraction tube. An example of a maximum specified displacement is the distance between a static position of the pick-up end 28 (e.g., centered within fluid container 12) and a most distant sidewall of the fluid container 12 at its closed end 20.

Another embodiment of the fluid extraction tube 24 is a tube that includes structural means for enabling flexure of the fluid extraction tube 24 at a position between its pick-up end 28 and the delivery end 30. Examples of such a structural means are a bellow-like device or a resilient sleeve device attached between two discrete segments of the fluid extraction tube 24. In such an embodiment, the structural means for enabling flexure permits a first relatively rigid portion of the fluid extraction tube 24 (e.g., a portion comprising the delivery end 30 of the fluid extraction tube 24) to pivot with respect to a second relatively rigid portion of the fluid extraction tube 24 (e.g., a portion comprising the pick-up end 28 of the fluid extraction tube 24).

The weighting element 26, in combination with the fluid extraction tube being adapted for enabling flexure at a position between its pick-up end 28 and the delivery end 30, provides for displacement of the pick-up end 28 of the fluid extraction tube 24 to a gravity-induced position within the fluid container 12. When the fluid dispensing apparatus 10 is tilted downward, resulting gravitational forces acting on the weighting element 26 results in the pickup end 28 being displaced forward (i.e., toward a relatively lowest portion of the fluid container 12 in this particular tilted position) to a first gravity-induced position GP1. When the fluid dispensing apparatus 10 is tilted upward, a resulting gravitational force acting on the weighting element 26 results in the pick-up end 28 being displaced rearward (i.e., toward the relatively lowest portion of the fluid container 12 in this particular tilted position) to a second gravity-induced position GP2. In embodiments of the fluid dispensing apparatus 10 wherein the pick-up end 28 is not constrained to only forward and rearward displacement, the pick-up end 28 displaces in a similar manner when the fluid dispensing apparatus 10 is tilted sideways.

Use of the term “the pick-up end 28 being displaced” is a relative one, in that one could argue that the weighting element 26 remains in a relatively static position (i.e., under the force of gravity) and a wall of the fluid container 12 moves toward the weighting element 26 as the fluid dispensing apparatus 10 is tilted in a corresponding direction. However, one could also argue that gravitational forces exerted on the weighting element 26 urge the pick-up end 28 toward a static position as the fluid dispensing apparatus 10 is tilted. Accordingly, it is disclosed herein that both perspectives of displacement are contemplated and appreciated.

As depicted in FIG. 1, the body 22 of the dispenser head assembly 14 is a body of a manual pump sprayer. Accordingly, a spray nozzle 32 (e.g., a variable spray nozzle) and a pump device 34 (e.g., a trigger energized suction/pressure chamber) are attached to the body 22. Other types of fluid dispensing head assemblies benefiting from a weighted fluid extraction tube are contemplated and disclosed herein. Examples of such other types of fluid dispensing head assemblies include, but are not limited to, manual-pump atomizing fluid dispensers, manual pump non-atomizing fluid dispensers, aerosol spray dispenser, hose-end fluid dispensers and the like.

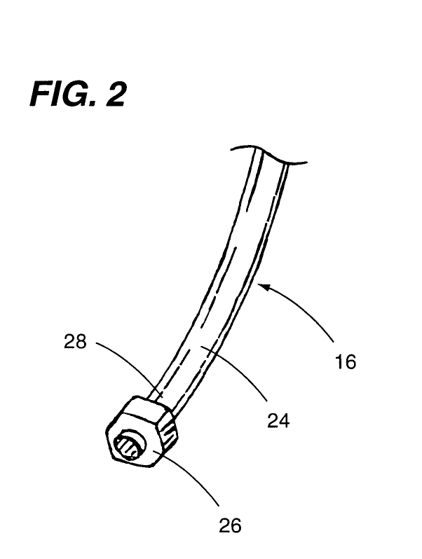

Various embodiments of the weighting element 26 and orientations of the weighting element 26 relative to the fluid extraction tube 24 are contemplated and disclosed herein. FIGS. 1 and 2 depict an embodiment of the weighting element 26 that includes a metallic threaded nut having the pick-up end 28 of the fluid extraction tube 24 extending approximately though a center of mass of the metallic threaded nut. A metallic threaded nut is one example of a weighting element configured for having a fluid extraction tube extending approximately though its center of mass.

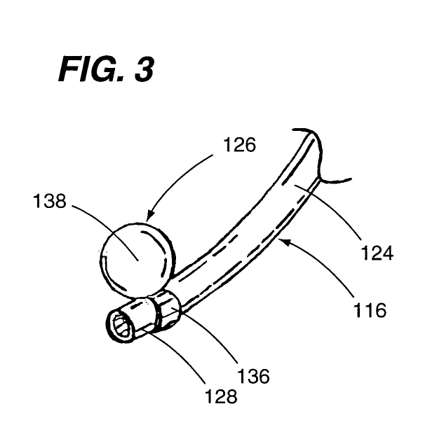

FIG. 3 depicts an embodiment of the weighting element 26 that includes a bracket 36 attached at the pick-up end 28 of the fluid extraction tube 24 and a ball bearing 38 attached to the bracket 36. The center of mass of the ball bearing is offset from a longitudinal axis of the fluid extraction tube 24. A ball bearing is one example of a weight configured for being attached to a fluid extraction tube via a bracket in a manner wherein a center of mass of the weight is offset from a longitudinal axis of the fluid extraction tube.

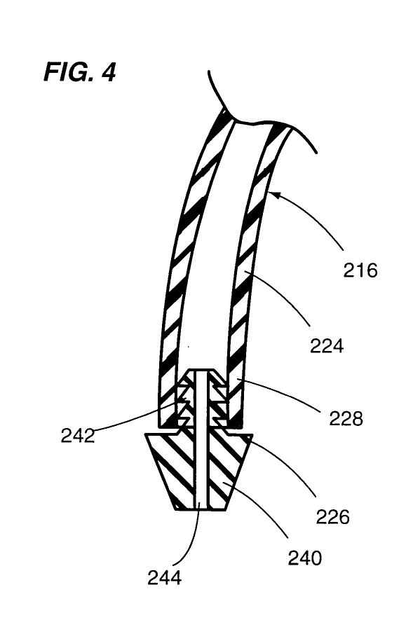

FIG. 4 depicts an embodiment of the weighting element 26 that includes a weight portion 40, a barbed nipple portion 42 integral with the weight portion 40 and a passage 44 extending through the weight portion 40 and the barbed nipple portion 42. The barbed nipple portion 42 is engaged within the pick-up end 28 of the fluid extraction tube 24. The longitudinal axis of the fluid extraction tube 24 extends approximately through the center of mass of the weight portion 40. It is contemplated and disclosed herein that the barbed nipple portion 42 may be configured with internal barbs and sized to fit over the pick-up end 28 of the fluid extraction tube 28, rather than within it.

Through the use of commercially-available weighting elements such as metallic threaded nuts or ball bearings or through the use of relatively low-cost custom manufactured weighting elements, the construction of a fluid dispensing apparatus in accordance with embodiments of the disclosures made herein could be accomplished with only require minor modification to conventional constructions. Such minor modification enables a fluid dispensing apparatus in accordance with embodiments of the disclosures made herein to be manufactured economically and at a production cost similar to conventional fluid dispensing apparatuses. Accordingly, from marketing, manufacturing and economic perspectives, it is believed that fluid dispensing apparatuses in accordance with embodiments of the disclosures made herein are capable of gaining market and manufacturer acceptance over a relatively short period of time.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

1. A weighted fluid extraction tube, comprising:
a fluid extraction tube having a fluid delivery end and a fluid pick-up end, wherein the fluid delivery end is configured for being attached to a body in a manner enabling fluid to be extracted from within a fluid container and dispensed via the body; and
a weighting element attached to the fluid extraction tube adjacent to the pick-up end of the fluid extraction tube, wherein the weighting element provides for displacement of the pick-up end of the fluid extraction tube to a gravity-induced position within the fluid container.

2. The weighed fluid extraction tube of claim 1 wherein the fluid extraction tube extends approximately though a center of mass of the weighting element.

3. The weighed fluid extraction tube of claim 1 wherein the weighting element includes a metallic threaded nut.

4. The weighed fluid extraction tube of claim 3 wherein the fluid extraction tube extends approximately though a center of mass of the metallic threaded nut.

5. The weighed fluid extraction tube of claim 1 wherein:
the weighting element includes a bracket attached to the fluid extraction tube and a weight attached to the bracket; and
a center of mass of the weight is offset from a longitudinal axis of the fluid extraction tube.

6. The weighed fluid extraction tube of claim 1 wherein:
the fluid extraction tube is flexible; and
a degree of flexibility of the fluid extraction tube is dependent upon a particular mass of the weighting element and a maximum specified and a maximum specified displacement of the pick-up end of the fluid extraction tube.

7. A fluid extraction assembly, comprising:
a body mountable on a neck portion of a fluid container;
a fluid extraction tube attached at a delivery end thereof to the body, wherein the fluid extraction tube is attached in a manner enabling fluid to be extracted from within the fluid container and dispensed via the body; and
a weighting element attached to the fluid extraction tube adjacent to a pick-up end of the fluid extraction tube, wherein the weighting element provides for displacement of the pick-up end of the fluid extraction tube to a gravity-induced position within the fluid container.

8. The fluid extraction assembly of claim 7 wherein the fluid extraction tube extends approximately though a center of mass of the weighting element.

9. The fluid extraction assembly of claim 7 wherein the weighting element includes a metallic threaded nut.

10. The fluid extraction assembly of claim 9 wherein the fluid extraction tube extends approximately though a center of mass of the metallic threaded nut.

11. The fluid extraction assembly of claim 7 wherein:
the weighting element includes a bracket attached to the fluid extraction tube and a weight attached to the bracket; and
a center of mass of the weight is offset from a longitudinal axis of the fluid extraction tube.

12. The fluid extraction assembly of claim 7 wherein:
the fluid extraction tube is flexible; and
a degree of flexibility of the fluid extraction tube is dependent upon a particular mass of the weighting element and a maximum specified displacement of the pick-up end of the fluid extraction tube.

13. The fluid extraction assembly of claim 7 wherein the body is one of a body for a manual pump non-atomizing fluid dispenser, a body for a manual pump atomizing fluid sprayer, a body for an aerosol spray dispenser and a body for a hose-end sprayer.

14. A fluid dispensing apparatus, comprising:
a fluid container having a neck portion and a closed end generally opposite the neck portion;
a body mounted on the neck portion of the fluid container;
a fluid extraction tube attached at a delivery end thereof to the body, wherein the fluid extraction tube is attached in a manner enabling fluid to be extracted from within the fluid container and dispensed via the body; and
a weighting element attached to the fluid extraction tube adjacent to a pick-up end of the fluid extraction tube, wherein the weighting element provides for displacement of the pick-up end of the fluid extraction tube to a gravity-induced position within the fluid container.

15. The fluid dispensing apparatus of claim 14 wherein the fluid extraction tube extends approximately though a center of mass of the weighting element.

16. The fluid dispensing apparatus of claim 14 wherein the weighting element includes a metallic threaded nut.

17. The fluid dispensing apparatus of claim 16 wherein the fluid extraction tube extends approximately though a center of mass of the metallic threaded nut.

18. The fluid dispensing apparatus of claim 14 wherein:
the weighting element includes a bracket attached to the fluid extraction tube and a weight attached to the bracket; and
a center of mass of the weight is offset from a longitudinal axis of the fluid extraction tube.

19. The fluid dispensing apparatus of claim 14 wherein:
the fluid extraction tube is flexible; and
a degree of flexibility of the fluid extraction tube is dependent upon a particular mass of the weighting element and a maximum specified displacement of the pick-up end of the fluid extraction tube.

20. The fluid dispensing apparatus of claim 14 wherein the body is one of a body for a manual pump non-atomizing fluid dispenser, a body for a manual pump atomizing fluid sprayer, a body for an aerosol spray dispenser and a body for a hose-end sprayer.
